(19) United States
(12) Patent Application Publication
(10) Pub. No.: US 2021/0032161 A1
(43) Pub. Date: Feb. 4, 2021

(54) CEMENT MANUFACTURE USING LATEX RESIDUAL MATERIAL

(71) Applicant: KBL Environmental (AB) Ltd., Leduc (CA)

(72) Inventors: Randall C. Gue, Edmonton (CA); Jeffrey J. Dirks, Edmonton (CA)

(21) Appl. No.: 16/527,339

(22) Filed: Jul. 31, 2019

(51) Int. Cl. C04B 7/44; C04B 7/38; C04B 7/28

(52) U.S. Cl. CPC C04B 7/4423; C04B 7/28; C04B 7/38

(57) ABSTRACT

A method of recycling latex paint residual material, such as unused latex paint, includes the step of mixing with cement precursor material, thermally treating the mixture in a kiln to produce clinker, and mixing the clinker with gypsum to product cement. The cement may be used in conventional ways, such as to produce concrete.

### FIELD OF THE INVENTION

The present invention relates to a method of making cement through the use of latex matter such as latex paint, residual waste paint from recycling activities and other latex residuals.

### BACKGROUND

Conventional Portland cement manufacturing involves blending raw materials in specified chemical proportions. The four main chemical components needed in the raw mix are calcium, silica, alumina and iron. These raw material chemical components traditionally come from materials including but not limited to limestone, sand, shale, clay, ash residuals from coal combustion and iron oxides. However, there is a large degree of flexibility in raw materials that can be used to obtain the correct chemical blend.

The resulting chemically correct raw mix is then ground to a fine powder and introduced to a kiln. Combustible materials are burned in the kiln and the temperature of the raw mix is raised to about 1450° C. The kiln burning process causes three transformative stages: 1) evaporation of any residual moisture in the raw materials, 2) calcination of calcium carbonate present (CO2 is liberated from the calcium carbonate) and, 3) a clinkering stage which occurs at over 1,400° C. in which calcium oxide reacts with silica and other metal oxides. The resulting chemically transformed material is called clinker. This material is rapidly cooled and typically put into storage waiting for the final step in the cement manufacturing process.

The clinker is finally blended with a small percentage of gypsum and ground into a fine powder generally referred to as Portland cement.

Portland cement is manufactured to comply with established standards, for example British Standard Specification BS 12, U.S. Standard ASTM C 150-67, West German Standard DIN 1164 and French Standard NF P 15-302, (cf. “Cement Standards of the World—Portland Cement and its derivatives”, Cembureau, Paris, 1968). Any cement complying with any such national standard is referred to as “standard Portland cement” and may be classified as Ordinary Portland Cement, Rapid Hardening or High Early Strength Cement, High Strength Portland Cement, Low Heat Portland Cement, Sulphate-Resisting Portland Cement and Air-Entraining Portland Cement, it being understood that where recognised additions are made to the clinker to obtain the product, these are to be taken as having been added.

The object of conventional cement making process is a product of consistent quality in excess of the minimum standards.

While Portland cement is a dry fine powder that reacts when mixed with water, concrete is Portland cement mixed with water, sand and rock as well as other components to create a product that is common building material for various constructions, such as bridges, roads, houses, and buildings. Portland cement is the glue the binds the other components together to make concrete.

A wide range of raw materials can be used to produce Portland cement. Provided the correct constituents are found, and no deleterious matter is allowed to be included at an unacceptable level, the manufacture of Portland cement depends solely upon the careful and accurate choice and treatment of the constituents. The materials should be treated with a complete knowledge of the chemical and mechanical operations of combining them, as this alone can secure the regular manufacture of a reliable product.

Therefore, there is a need in the art for methods of manufacturing Portland cement which recycles or reuses latex paint residual.

### SUMMARY OF THE INVENTION

In general terms, the invention comprises a method of recycling or reusing latex paint residuals, comprising the step of mixing the latex paint residual material with other cement precursor materials, thermally treating the raw mixture in a kiln to produce clinker, and mixing the clinker with gypsum to product cement. The cement may be used in conventional ways, such as to produce concrete. The method may comprise a wet or dry method of making cement.

### DETAILED DESCRIPTION

The present invention comprises a method of recycling or reusing latex paint residuals, comprising the step of mixing the latex paint residual material with other cement precursor materials, thermally treating the mixture in a kiln to produce clinker, and mixing the clinker with gypsum to product cement. The cement may be used in conventional ways, such as to produce concrete.

As used herein, “latex paint residuals or residual materials” includes water-based latex paint or latex paint waste, water based paints, water-soluble pigments and water based coating, and may be in liquid, solid or semisolid form. Latex paint residual materials contain significant concentrations of silica, alumina, iron, and calcium. Latex paint residuals may be collected from residential, commercial and/or industrial activities where excess or otherwise undesirable paints, coatings and stains are collected. The substitution of raw material feedstocks in cement manufacturing with latex paint residuals comprises the step of mixing latex paint residual material and a cement precursor material at a suitable ratio to produce a raw mix having a desired chemical composition.

The cement precursor material may comprise any material conventionally used in the manufacture of cement, and may include limestone, shells, and chalk or marl combined with shale, clay, slate, blast furnace slag, silica sand, and iron ore combustion ash, lime waste, alumina, calcium carbonate, clay fines, diatomaceous earth, perlite, slag fines, aluminum dross fines, pyrite ashes, cinder fines, shale fines, bauxite, silica sand and dolomite, and/or mixtures thereof.

The cement manufacturing raw mix is then combusted in a kiln, such as a rotary cement kiln, to produce cement clinker. This stage is part of conventional cement manufacturing, well known to those skilled in the art, and further description is unnecessary here.

The method may comprise a wet or dry method of making cement.

In some embodiments, the latex paint residuals are added to one cement precursor material, which is then used in the normal course. For example, an amount of latex paint residual may be added to bottom ash to create a latex-modified bottom ash, which is then combined with other cement precursor materials in the normal course.

Alternatively, the latex paint residuals may be added at the time the raw mix is formulated, as a separate ingredient in its own right.

In some embodiments, the latex paint residuals may comprise 0.1% to about 25% (by weight) of the total raw mix, preferably between about 1% to about 20%, and more preferably about 2% to about 15%.

### EXAMPLES

The following examples are intended to illustrate specific embodiments of the invention described herein, and not be limiting of the claimed invention in any way.

### Example 1

A bench scale trial was conducted to assess the chemical composition and conveyability of the admixture at 5%, 10% and 15% (w/w) liquid latex paint to coal ash. The mixtures were analysed for parameters relevant to cement manufacturing and deemed to be acceptable as a modified coal ash feedstock.

### Example 2

A batch scale trial was conducted to assess scaling up to batch levels. A 10% (w/w) mixture of latex paint and coal ash was generated by blending 13700 kg of liquid latex paint and 124,000 kg of coal bottom ash. The material was mixed using excavation and soil treatment equipment. The resulting material was deemed acceptable in for processing in consistency and chemistry.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated. To the extent that the following description is of a specific embodiment or a particular use of the invention, it is intended to be illustrative only, and not limiting of the claimed invention.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to combine, affect or connect such aspect, feature, structure, or characteristic with other embodiments, whether or not such connection or combination is explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited, and such terms refer to ranges that can be subsequently broken down into sub-ranges as discussed above. In the same manner, all ratios recited herein also include all sub-ratios falling within the broader ratio.

1. A method of manufacturing cement clinker, comprising the steps of mixing latex paint residual material with a cement precursor to produce a raw mixture, and combusting the raw mixture in a kiln to produce cement clinker.

2. The method of claim 1 wherein the cement precursor comprises limestone, shells, and chalk or marl combined with shale, clay, slate, blast furnace slag, silica sand, iron ore, combustion ash (coal ash or bottom ash), lime waste, alumina, calcium carbonate, clay fines, diatomaceous earth, perlite, slag fines, aluminum dross fines, pyrite ashes, cinder fines, shale fines, bauxite, silica sand and dolomite, and/or mixtures thereof.

3. The method of claim 2 wherein the latex paint residual material is mixed with a single precursor material, which is then used as a modified precursor material to produce the raw mix.

4. The method of claim 2 wherein the latex paint residual material is mixed with all other precursor materials at substantially the same time to produce the raw mix.

5. Cement clinker comprising the combustion end-product of a mixture of latex paint residual and a cement precursor.

6. The clinker of claim 3 wherein the cement precursor comprises limestone, shells, and chalk or marl combined with shale, clay, slate, blast furnace slag, silica sand, iron ore, combustion ash (coal ash or bottom ash), lime waste, alumina, calcium carbonate, clay fines, diatomaceous earth, perlite, slag fines, aluminum dross fines, pyrite ashes, cinder fines, shale fines, bauxite, silica sand and dolomite, and/or mixtures thereof.
